(19) United States
(12) Patent Application Publication
(10) Pub. No.: US 2025/0167215 A1
(43) Pub. Date: May 22, 2025

(54) ANODE MIXTURE AND LITHIUM SECONDARY BATTERY

(71) Applicant: TOYOTA JIDOSHA KABUSHIKI KAISHA, Toyota-shi (JP)

(72) Inventor: Shinsuke MATSUHARA, Miyohsi-shi (JP)

(73) Assignee: TOYOTA JIDOSHA KABUSHIKI KAISHA, Toyota-shi (JP)

(21) Appl. No.: 18/909,953

(22) Filed: Oct. 9, 2024

(30) Foreign Application Priority Data
Nov. 17, 2023 (JP) 2023-195969

(51) Int. Cl. H01M 4/36; C01B 32/21; H01M 4/38; H01M 4/587; H01M 4/62

(52) U.S. Cl. CPC H01M 4/364; C01B 32/21; H01M 4/366; H01M 4/386; H01M 4/587; H01M 4/625; C01P 2002/82; C01P 2004/32; C01P 2004/80; C01P 2006/40

(57) ABSTRACT

An anode mixture includes a plurality of carbon particles and a plurality of silicon-based particles. The plurality of carbon particles includes coated graphite particles. The coated graphite particles include scaly graphite particles and a carbon film doped with boron. The carbon film covers at least a part of the surface of the scaly graphite particles. The content of the plurality of silicon-based particles with respect to the plurality of carbon particles is 5% by mass to 60% by mass. The content of the coated graphite particles with respect to the plurality of carbon particles is 0.8 mass % to 85.0 mass %. The intensity ratio (D/G) of the Raman spectrum of the coated graphite particles is from 0.3 to 0.8.

### CROSS-REFERENCE TO RELATED APPLICATION

This application claims priority to Japanese Patent Application No. 2023-195969 filed on Nov. 17, 2023, incorporated herein by reference in its entirety.

### BACKGROUND

### 1. Technical Field

The present disclosure relates to anode mixtures and lithium secondary batteries.

### 2. Description of Related Art

Lithium secondary batteries are used for information communication technology (e.g., personal computers and smartphones), vehicle installation, energy storage, etc.

Japanese Unexamined Patent Application Publication No. 2004-103391 (JP 2004-103391 A) discloses a non-aqueous electrolyte lithium secondary battery. This non-aqueous electrolyte lithium secondary battery includes an anode, a specific cathode, and a non-aqueous electrolyte solution. The anode includes a carbon material that can be doped and undoped with lithium. The carbon material consists of a specific graphite that does not contain boron and a specific boron-containing graphite.

### SUMMARY

However, the non-aqueous electrolyte lithium secondary battery disclosed in JP 2004-103391 A has room for improvement in capacity retention rate.

The present disclosure has been made in view of the above circumstances. An issue to be solved by an embodiment of the present disclosure is to provide an anode mixture that can improve the capacity retention rate of a lithium secondary battery, and a lithium secondary battery with a high capacity retention rate.

The means for addressing the above issue includes the following aspects.

<1> An anode mixture containing
a plurality of carbon particles (A) and a plurality of silicon-based particles (B), in which the carbon particles (A) include a coated graphite particle (A1),
the coated graphite particle (A1) includes:
a scaly graphite particle (a1); and
a carbon film (a2) doped with boron and covering at least part of a surface of the scaly graphite particle (a1),
an intensity ratio (D/G) of a Raman spectrum of the coated graphite particle (A1) is 0.3 to 0.8,
a content (B/A) of the silicon-based particles (B) relative to the carbon particles (A) is 5 mass % to 60 mass %, and
a content (A1/A) of the coated graphite particle (A1) relative to the carbon particles (A) is 0.8 mass % to 85.0 mass %.
<2> The anode mixture according to <1>, in which the scaly graphite particle (a1) is doped with boron.
<3> The anode mixture according to <1> or <2>, in which a doping amount of the boron in the carbon film (a2) is 1.0 atm % or more.
<4> The anode mixture according to any one of <1> to <3>, in which: the carbon particles (A) further include a plurality of spherical graphite particles (A2); and a doping amount of the boron in the carbon film (a2) is 0.2 atm % to 2.4 atm %.
<5> A lithium secondary battery including an anode including the anode mixture according to any one of <1> to <4>.

The present disclosure provides an anode mixture that can improve the capacity retention rate of a lithium secondary battery, and a lithium secondary battery with a high capacity retention rate.

### DETAILED DESCRIPTION OF EMBODIMENTS

In the present disclosure, a numerical range indicated by using “from” means a range including the numerical values described before and after “from” as the minimum value and the maximum value, respectively. In the numerical range described in the present disclosure in a stepwise manner, the upper limit value or the lower limit value described in a certain numerical range may be replaced with the upper limit value or the lower limit value of the numerical range described in another stepwise manner. In the numerical ranges described in the present disclosure, the upper limit value or the lower limit value described in a certain numerical range may be replaced with the value shown in the examples. In the present disclosure, a combination of two or more preferred embodiments is a more preferred embodiment. In the present disclosure, the amount of each component means the total amount of a plurality of substances unless otherwise specified, when a plurality of substances corresponding to each component are present. In the present disclosure, the term “step” is included in the term as long as the intended purpose of the step is achieved, even if it is not clearly distinguishable from other steps as well as independent steps.

### (1) Anode Mixture

The anode mixture contains a plurality of carbon particles (A) and a plurality of silicon-based particles (B). The plurality of carbon particles (A) includes coated graphite particles (A1). The coated graphite particles (A1) have scaly graphite particles (a1) and a boron-doped carbon film (a2). Carbon film (a2) covers at least a part of the surface of the scaly graphite particles (a1). The intensity ratio (D/G) of the Raman spectrum of the coated graphite particles (A1) (hereinafter, also simply referred to as “intensity ratio (D/G)”) is 0.3 to 0.8. The content (B/A) of the plurality of silicon-based particles (B) relative to the plurality of carbon particles (A) (hereinafter, also simply referred to as “content (B/A)”) is 5% by mass to 60% by mass. The content (A1/A) of the coated graphite particles (A1) relative to the plurality of carbon particles (A) (hereinafter, simply referred to as “content (A1/A)”) is 0.8 mass % to 85.0 mass %.

In the present disclosure, the “anode mixture” indicates the solid content of the anode mixture layer included in the negative electrode of the lithium secondary battery. The lithium secondary battery may be a battery including a solid electrolyte or a battery including a non-aqueous electrolyte. “Carbon particle” refers to a particle comprising carbon. “Graphite particles” refer to particles comprising graphite. “Scale” means a shape with an aspect ratio of 2.1 or more. “Aspect ratio” refers to the ratio of the major diameter of a particle to the minor diameter of the particle. “Silicon-based particles” refer to particles that contain silicon (Si). “Carbon film” refers to a film comprising carbon. The “intensity ratio (D/G) of the Raman spectrum” indicates the ratio of the peak intensity of the D-band (1360 cm⁻¹) derived from the defective structure to the peak intensity of the G-band (1580 cm⁻¹) derived from the graphite structure (SP2 bond) in the Raman spectrum of the surface of the coated graphite particle (A1). The lower the intensity ratio (D/G) of the Raman spectrum, the higher the crystallinity of the surface of the coated graphite particles (A1) (i.e., carbon film (a2)).

Since the anode mixture of the present disclosure has the above-described configuration, the capacity retention ratio of the lithium secondary battery can be improved. This effect is presumed to be due to, but not limited to, the following reasons. When the carbon film doped with boron is coated on the scaly graphite particles, the electronic conductivity is improved. Therefore, the conductive path for the silicon-based particles is easily formed. As a result, it is presumed that the anode mixture of the present disclosure can improve the capacity retention rate of the lithium secondary battery.

### (1.1) Carbon Particles (A)

The anode mixture of the present disclosure contains a plurality of carbon particles (A). The plurality of carbon particles (A) function as a negative electrode active material. Examples of the material constituting the carbon particles (A) include graphite, hard carbon, and soft carbon. Of the above, graphite is preferable. The graphite may be natural graphite or artificial graphite. The carbon particles (A) may be coated with an amorphous carbon material.

### (1.1.1) Coated Graphite Particles (A1)

The plurality of carbon particles (A) comprises coated graphite particles (A1). The coated graphite particles (A1) have scaly graphite particles (a1) and a boron-doped carbon film (a2). Carbon film (a2) may cover the entire surface of the scaly graphite particles (a1) or may cover a portion of the surface of the scaly graphite particles (a1).

The intensity ratio (D/G) is from 0.3 to 0.8. The intensity ratio (D/G) of 0.3 to 0.8 indicates that the carbon film (a2) has low crystallinity. The intensity ratio (D/G) may be greater than or equal to 0.4 and greater than or equal to 0.5. The intensity ratio (D/G) may be less than or equal to 0.7 and less than or equal to 0.5, and may be 0.4 or less.

The content (A1/A) is 0.8 mass % to 85.0 mass %. The content (A1/A) may be 5.0% by mass or more, may be 20.0% by mass or more, or may be 40.0% by mass or more. The content (A1/A) may be 50.0% by mass or less, may be 35.0% by mass or less, and may be 25.0% by mass or less.

### (1.1.1.1) Scaly Graphite Particles (a1)

The graphite constituting the scaly graphite particles (a1) may be natural graphite or artificial graphite.

Boron is preferably doped into scaly graphite particles (a1). As a result, the anode mixture can improve the capacity retention rate of the lithium secondary battery than in the configuration in which the boron is not doped into the scaly graphite particles (a1).

When boron is doped into the scaly graphite particles (a1), the doping amount of boron in the scaly graphite particles (a1) is not particularly limited, and may be 0.2 atm % or more. The doping amount of boron in the scaly graphite particles (a1) may be 1.0 atm % or more, or may be 2.0 atm % or more. The doping amount of boron in the scaly graphite particles (a1) may be 3.6 atm % or less, or 3.5 atm % or less. The method for measuring the doping amount of boron is the same as that described in the Examples.

The aspect-ratio of the scaly graphite particles (a1) may be 2.1 or more, 3.0 or more, or 3.4 or more. The aspect-ratio of the scaly graphite particles (a1) may be 10.0 or less, 4.0 or less, or 3.8 or less.

The mean particle diameter of the plurality of scaly graphite particles (a1) is not particularly limited, and may be 2 m to 40 m, or 4 m to 26 m. The “average particle diameter” indicates a particle diameter (median diameter) corresponding to a cumulative frequency of 50% by volume from a fine particle side having a small particle diameter in a volume-based particle size distribution based on laser diffraction and light scattering.

### (1.1.1.2) Carbon Film (a2)

The carbon film (a2) may be an amorphous carbon film. Carbon film (a2) is obtained, for example, by mixing scaly graphite particles (a1) with a pitch and baking.

The ratio (a2/A1) of the carbon film (a2) to the total amount of the coated graphite particles (A1) may be 2% by mass or more and may be 5% by mass or more. The percentage (a2/A1) may be 20% by weight or less and may be 10% by weight or less.

The doping amount of boron in the carbon film (a2) is not particularly limited, and may be 0.2 atm % or more, may be 1.0 atm % or more, or may be 1.4 atm % or more. The doping amount of boron in carbon film (a2) may be less than or equal to 2.5 atm %, or less than or equal to 2.4 atm %. The method for measuring the doping amount of boron is the same as that described in the Examples.

When boron is doped into scaly graphite particles (a1), the doping amount of boron in carbon film (a2) is preferably not less than 1.0 atm %. This allows the anode mixture to improve the capacity retention of the lithium secondary battery more than a configuration in which the doping amount of boron in the carbon film (a2) less than 1.0 atm %.

### (1.1.2) Spherical Graphite Particles (A2)

The plurality of carbon particles (A) may further include spherical graphite particles (A2). “Spherical” means a shape with an aspect ratio of less than 2.1. The graphite constituting the spherical graphite particles (A2) may be natural graphite or artificial graphite.

The spherical graphite particles (A2) may be doped with boron or may be undoped with boron. When the spherical graphite particles (A2) are doped with boron, the doping amount of boron in the spherical graphite particles (A2) may be the same as that exemplified as the doping amount of boron in the scaly graphite particles (a1).

The spherical graphite particles (A2) may have an aspect ratio of less than 2.1, 1.9 or less, or 1.7 or more. The spherical graphite particles (A2) may have an aspect ratio of 1.0 or more.

The mean particle diameter of the plurality of spherical graphite particles (A2) is not particularly limited, and may be 2 m to 30 m, or 4 m to 26 m. The method for measuring the average particle diameter is the same as the method for measuring the average particle diameter of scaly graphite particles (a1).

The content (A2/A) of the plurality of spherical graphite particles (A2) relative to the plurality of carbon particles (A) may be 60.0% by mass or more, 75.0% by mass or more, or 85.0% by mass or more. The content (A2/A) may be 98.5% by mass or less, 92.0% by mass or less, or 90.0% by mass or less.

### (1.1.3) Preferred Embodiment

The plurality of carbon particles (A) further includes a plurality of spherical graphite particles (A2), and a doping amount of the boron in the carbon film (a2) is preferably 0.2 atm % to 2.4 atm %. Thus, the anode mixture can further improve the capacity retention ratio of the lithium secondary battery.

### (1.2) Silicon-Based Particles (B)

The anode mixture contains a plurality of silicon-based particles (B). The plurality of silicon-based particles (B) function as a negative electrode active material. Examples of the material constituting silicon-based particles (B) include Si alone (silicon), Si alloy, silicon monoxide (SiO), and silicon dioxide (SiO₂). Si alloy preferably contains Si as a main component.

The aspect ratio of silicon-based particles (B) is not particularly limited, and may be less than 2.1, 1.9 or less, or 1.7 or more. The aspect-ratio of silicon-based particles (B) may be 1.0 or more.

The mean particle size of the plurality of silicon-based particles (B) is not particularly limited, and may be 0.01 m to 10.0 m or 0.5 m to 8.0 m. The method for measuring the average particle diameter is the same as the method for measuring the average particle diameter of scaly graphite particles (a1).

The content (B/A) is from 5% to 60% by weight. The content (B/A) may be 10% by mass or more or 15% by mass or more. The content (B/A) may be 40% by mass or less, 30% by mass or less, or 25% by mass or less.

### (1.3) Binder

The anode mixture may further contain a binder. Examples of the binder include polyvinylidene fluoride (PVDF), carboxymethylcellulose, rubber-based binders (e.g., butadiene rubber, hydrogenated butadiene rubber, etc.), fluoride-based binders (e.g., polyvinylidene fluoride-polyhexafluoropropylene copolymer (PVDF-HFP), polytetrafluoroethylene (PTFE), etc.), and polyolefin-based thermoplastic resins (e.g., polyethylene, polypropylene, polystyrene, etc.). The content of the binder may be 0.1% by mass to 10% by mass with respect to the total amount of the anode mixture.

### (1.4) Conductive Aid

The anode mixture may further contain a conductive auxiliary agent. Examples of the conductive auxiliary agent include carbon nanotubes (CNT), carbon blacks (e.g., acetylene black, furnace black, Ketjen black, and the like), and the like. The content of the conductive auxiliary agent may be 0.1% by mass to 10% by mass with respect to the total amount of the anode mixture.

### (2) Lithium Secondary Battery

The lithium secondary battery of the present disclosure includes a negative electrode. The negative electrode includes the anode mixture of the present disclosure. Accordingly, the capacity retention ratio of the lithium secondary battery of the present disclosure is excellent.

The lithium secondary battery of the present disclosure generally further includes a positive electrode and an ion conductive medium in addition to the negative electrode. The ion conducting medium is interposed between the positive electrode and the negative electrode and conducts carrier ions. Examples of the ion conductive medium include a non-aqueous electrolyte solution, a non-aqueous gel electrolyte solution, a solid ion conductive polymer, and an inorganic solid electrolyte.

Hereinafter, a lithium secondary battery (hereinafter, also referred to as a “non-aqueous battery”) using a non-aqueous electrolyte solution will be described.

### (2.1) Non-Aqueous Battery

The non-aqueous battery includes a negative electrode of the present disclosure, a positive electrode, a separator disposed between the positive electrode and the negative electrode, and a non-aqueous electrolyte.

### (2.1.1) Negative Electrode

The negative electrode may have an anode mixture layer and may further have a positive electrode current collector (for example, copper foil or the like). The anode mixture layer is laminated on at least one main surface of the negative electrode current collector. The anode mixture layer includes the anode mixture of the present disclosure.

### (2.1.2) Positive Electrode

The positive electrode may include a positive electrode mixture layer, and may further include a positive electrode current collector (e.g., aluminum foil). The positive electrode mixture layer is laminated on at least one main surface of the positive electrode current collector.

The positive electrode mixture layer includes a positive electrode active material. The active cathode material releases lithium ions into or occludes from the non-aqueous electrolyte. The positive electrode active material may be any known positive electrode active material (e.g., LiNiO₂, LiNi_{1/3}Co_{1/3}Mn_{1/3}O₂). The positive electrode mixture layer may further contain a known conductive material (e.g., carbon black, etc.), lithium phosphate, a binder (e.g., polyvinylidene fluoride, etc.).

### (2.1.3) Separator

The separator maintains a gap between the positive electrode and the negative electrode to prevent the occurrence of a contact short circuit, and allows lithium ions to pass through the separator. Examples of the separator include a porous resin sheet and a nonwoven fabric. Examples of the material of the porous resin sheet include polyolefins (polypropylene, polyethylene, and the like). Examples of the material of the nonwoven fabric include polypropylene, polyethylene terephthalate, and methylcellulose. The separator may have a known configuration.

### (2.1.4) Non-Aqueous Electrolyte

The non-aqueous electrolyte solution may include a non-aqueous solvent and a lithium salt. Examples of the lithium salt include LiClO₄, LiAsF₆, LiPF₆, LiBF₄, LiCF₃SO₃, LiN(FSO₂)₂, LiN(CF₃SO₂)₂. Examples of the non-aqueous solvent include cyclic carbonates (e.g., ethylene carbonate, etc.), linear carbonates (e.g., dimethyl carbonate, ethyl methyl carbonate, etc.), cyclic esters (e.g., γ-butyrolactone, γ-valerolactone, etc.), linear esters (e.g., methyl formate, methyl acetate, etc.), and ethers (e.g., dimethoxyethane, ethoxymethoxyethane, etc.). The non-aqueous electrolytic solution may contain an additive (for example, vinylene carbonate, lithium bis(oxalato)borate, or the like).

### (2.1.5) Case

Non-aqueous batteries usually have a case. The case contains a positive electrode, a negative electrode, a separator, and a non-aqueous electrolyte. The case is not particularly limited, and examples thereof include a laminate film (for example, an aluminum sheet, etc.), a battery can (for example, a cylindrical shape, a square shape, a coin shape, etc.), and the like.

Hereinafter, the present disclosure will be described in more detail with reference to Examples, but the disclosure of the present disclosure is not limited to these Examples.

### [1] Examples and Comparative Examples

### [1.1] Raw Materials

The following materials were prepared as a raw material of the anode mixture.

### [1.1.1] Scaly Graphite Particles (a1)

[1.1.1.1] Scaly Graphite Particles (a1-1)

As scaly graphite particles (a1) (negative electrode active material), a plurality of scaly graphite particles not doped with boron (a1-1) (material of particles graphite, aspect ratio of particles: 3.3) were prepared.

[1.1.1.2] Scaly Graphite Particles (a1-2)

As scaly graphite particles (a1) (negative electrode active material), a plurality of scaly graphite particles (a1-2) doped with boron were prepared. Specifically, boron carbide (B₄C) as a boron precursor and a plurality of scaly graphite particles (material of particles: graphite, aspect ratio of particles: 3.5) were mixed to obtain a mixture. The blending ratio of boron carbide (B₄C) was 3.0% by mass with respect to the plurality of scaly graphite particles. The mixture was calcined at 2800° C. under an argon atmosphere for 2 hours. As a result, a plurality of scaly graphite particles (a1-2) was obtained.

Boron doping of several scaly graphite particles (a1-2) was measured using XPS (X-ray photoelectron spectroscopy). Specifically, the doping amount of boron was calculated from the peaks (B-C bonding and assignment) in 188 eV. The boron doping of the plurality of scaly graphite particles (a1-2) was measured in 1.4 atm %.

[1.1.1.3] Scaly Graphite Particles (a1-3)

As scaly graphite particles (a1) (negative electrode active material), a plurality of scaly graphite particles (a1-3) doped with boron were prepared. In detail, a plurality of scaly graphite particles (a1-3) was obtained in the same manner as in the preparation of scaly graphite particles (a1-2), except that the blending ratio of boron carbide (B₄C) was changed to 0.5 mass % for the plurality of scaly graphite particles. The boron doping of the scaly graphite particles (a1-3) was measured in 0.2 atm %.

[1.1.1.4] Scaly Graphite Particles (a1-4)

As scaly graphite particles (a1) (negative electrode active material), a plurality of scaly graphite particles (a1-4) doped with boron were prepared. Specifically, a plurality of scaly graphite particles (a1-4) was obtained in the same manner as in the preparation of scaly graphite particles (a1-2) except that the blending ratio of boron carbide (B₄C) was changed to 10.0 mass % for the plurality of scaly graphite particles. The boron doping of the scaly graphite particles (a1-4) was measured in 3.5 atm %.

### [1.1.2] Coated Graphite Particles (A1)

### [1.1.2.1] Coated Graphite Particles (X1)

Coated graphite particles (X1) were prepared as coated graphite particles (X) having a carbon film. Specifically, a mixture was obtained by mixing a coal touch pitch as a carbon raw material and a plurality of scaly graphite particles (a1-1). The content of the call touch pitch was 5% by weight with respect to the plurality of scaly graphite particles (a1-1). The mixture was calcined at 1000° C. in an argon atmosphere. As a result, a plurality of coated graphite particles (X1) was obtained.

### [1.1.2.2] Coated Graphite Particles (A1-1)

Coated graphite particles (A1-1) were prepared as coated graphite particles (A1) having a boron-doped low crystalline-carbon film (a2). Specifically, a mixture was obtained by mixing a coal touch pitch as a carbon raw material, a plurality of scaly graphite particles (a1-1), and boron carbide as a boron raw material (B₄C). The content of the call touch pitch was 5% by weight with respect to the plurality of scaly graphite particles (a1-1). The content of boron carbide (B₄C) was 1 mass % with respect to the plurality of scaly graphite particles (a1-1). The mixture was calcined at 1000° C. in an argon atmosphere. As a result, a plurality of coated graphite particles (A1-1) was obtained.

The boron doping of boron-doped low-crystalline-carbon films (a2) of a plurality of coated graphite particles (A1-1) was measured using XPS (X-ray photoelectron spectroscopy). Specifically, the doping amount of boron was calculated from the peaks (B-C bonding and assignment) in 188 eV. The boron doping of the boron-doped low-crystallinity-carbon film (a2) of the plurality of coated graphite particles (A1-1) was measured in 0.2 atm %.

Raman spectroscopy (part number: DXR3) from Thermo Fisher Scientific was used to measure the intensity ratio (D/G) of the Raman spectra of coated graphite particles (A1-1). The laser wave length was 532 nm. The intensity ratio (D/G) of the coated graphite particles (A1-1) was 0.3.

### [1.1.2.3] Coated Graphite Particles (A1-2)

Coated graphite particles (A1-2) were prepared as coated graphite particles (A1) having a boron-doped low crystalline-carbon film (a2). Specifically, a plurality of coated graphite particles (A1-2) was obtained in the same manner as in the preparation of coated graphite particles (A1-1), except that the scaly graphite particles (a1-1) were changed to scaly graphite particles (a1-2). The boron doping of the boron-doped low-crystallinity-carbon film (a2) of the plurality of coated graphite particles (A1-2) was measured in 0.2 atm %. The intensity ratio (D/G) of the coated graphite particles (A1-2) was 0.4.

### [1.1.2.4] Coated Graphite Particles (A1-3)

Coated graphite particles (A1-3) were prepared as coated graphite particles (A1) having a boron-doped low crystalline-carbon film (a2). Specifically, a plurality of coated graphite particles (A1-3) was obtained in the same manner as in the preparation of coated graphite particles (A1-1), except that the content of boron carbide (B₄C) was changed to 3% by weight with respect to the plurality of scaly graphite particles (a1-2). The boron doping of the boron-doped low-crystallinity-carbon film (a2) of the plurality of coated graphite particles (A1-3) was measured in 1.4 atm %. The intensity ratio (D/G) of the coated graphite particles (A1-3) was 0.3.

### [1.1.2.5] Coated Graphite Particles (A1-4)

Coated graphite particles (A1-4) were prepared as coated graphite particles (A1) having a boron-doped low crystalline-carbon film (a2). Specifically, a plurality of coated graphite particles (A1-4) was obtained in the same manner as in the preparation of coated graphite particles (A1-1), except that the content of boron carbide (B₄C) was changed to 10 mass % with respect to a plurality of scaly graphite particles (a1-2). The boron doping of the boron-doped low-crystallinity-carbon film (a2) of the plurality of coated graphite particles (A1-4) was measured in 2.4 atm %. The intensity ratio (D/G) of the coated graphite Particles (A1-4) was 0.4.

### [1.1.2.6] Coated Graphite Particles (A1-5)

Coated graphite particles (A1-5) were prepared as coated graphite particles (A1) having a boron-doped low crystalline-carbon film (a2). Specifically, a plurality of coated graphite particles (A1-5) was obtained in the same manner as in the preparation of coated graphite particles (A1-2), except that the content of boron carbide (B₄C) was changed to 3% by weight with respect to the plurality of scaly graphite particles (a1-2). The boron doping of the boron-doped low-crystallinity-carbon film (a2) of the plurality of coated graphite particles (A1-5) was measured in 1.3 atm %. The intensity ratio (D/G) of the coated graphite particles (A1-5) was 0.3.

### [1.1.2.7] Coated Graphite Particles (A1-6)

Coated graphite particles (A1-6) were prepared as coated graphite particles (A1) having a boron-doped low crystalline-carbon film (a2). Specifically, a plurality of coated graphite particles (A1-6) was obtained in the same manner as in the preparation of coated graphite particles (A1-2), except that the content of boron carbide (B₄C) was changed to 10 mass % with respect to a plurality of scaly graphite particles (a1-2). The boron doping of the boron-doped low-crystallinity-carbon film (a2) of the plurality of coated graphite particles (A1-6) was measured in 2.4 atm %. The intensity ratio (D/G) of the coated graphite particles (A1-6) was 0.5.

### [1.1.2.8] Coated Graphite Particles (A1-7)

Coated graphite particles (A1-7) were prepared as coated graphite particles (A1) having a boron-doped low crystalline-carbon film (a2). Specifically, a plurality of coated graphite particles (A1-7) was obtained in the same manner as in the preparation of coated graphite particles (A1-2) except that the firing temperature was changed to 1300° C. The boron doping of the boron-doped low-crystallinity-carbon film (a2) of the plurality of coated graphite particles (A1-7) was measured in 0.2 atm %. The intensity ratio (D/G) of the coated graphite particles (A1-7) was 0.3.

### [1.1.2.9] Coated Graphite Particles (A1-8)

Coated graphite particles (A1-8) were prepared as coated graphite particles (A1) having a boron-doped low crystalline-carbon film (a2). Specifically, a plurality of coated graphite particles (A1-8) was obtained in the same manner as in the preparation of coated graphite particles (A1-2) except that the firing temperature was changed to 900° C. The boron doping of the boron-doped low-crystallinity-carbon film (a2) of the plurality of coated graphite particles (A1-8) was measured in 0.2 atm %. The intensity ratio (D/G) of the coated graphite particles (A1-8) was 0.8.

### [1.1.2.10] Coated Graphite Particles (X2)

Coated graphite particles (X2) were prepared as coated graphite particles (X) having a carbon film. Specifically, a plurality of coated graphite particles (X2) was obtained in the same manner as in the preparation of coated graphite particles (A1-2) except that the firing temperature was changed to 700° C. The boron doping of the carbon film of the plurality of coated graphite particles (X2) was measured in 0.2 atm %. The intensity ratio (D/G) of the coated graphite particles (X2) was 0.9.

### [1.1.2.11] Coated Graphite Particles (A1-9)

Coated graphite particles (A1-9) were prepared as coated graphite particles (A1) having a boron-doped low crystalline-carbon film (a2). Specifically, a plurality of coated graphite particles (A1-9) was obtained in the same manner as in the preparation of coated graphite particles (A1-2), except that the scaly graphite particles (a1-2) were changed to scaly graphite particles (a1-3). The boron doping of the boron-doped low-crystallinity-carbon film (a2) of the plurality of coated graphite particles (A1-9) was measured in 0.2 atm %. The intensity ratio (D/G) of the coated graphite particles (A1-9) was 0.4.

### [1.1.2.12] Coated Graphite Particles (A1-10)

Coated graphite particles (A1-10) were prepared as coated graphite particles (A1) having a boron-doped low crystalline-carbon film (a2). Specifically, a plurality of coated graphite particles (A1-10) was obtained in the same manner as in the preparation of coated graphite particles (A1-2), except that the scaly graphite particles (a1-2) were changed to scaly graphite particles (a1-4). The boron doping of the boron-doped low-crystallinity-carbon film (a2) of the plurality of coated graphite particles (A1-10) was measured in 0.2 atm %. The intensity ratio (D/G) of the coated graphite particles (A1-10) was 0.4.

### [1.1.3] Spherical Graphite Particles (A2)

As spherical graphite particles (A2) (negative electrode active material) not doped with boron, a plurality of spherical graphite particles (A2-1) (material of particles: artificial graphite) were prepared.

### [1.1.4] Silicon-Based Particles (B)

As silicon-based particles (B) (negative electrode active material), a plurality of silicon particles (B-1) (material of particles: silicon) were prepared.

### [1.2] Examples 1 to 17 and Comparative Examples 1 to 6

A plurality of coated graphite particles (A1) shown in Table 1 and a plurality of spherical graphite particles (A2-1) were mixed to obtain a plurality of carbon particles (A). The ratio of the plurality of coated graphite particles (A1) to the sum of the plurality of coated graphite particles (A1) and the plurality of spherical graphite particles (A2-1) (i.e., the plurality of carbon particles (A)) (A1/A) was the ratio shown in Table 1. A plurality of carbon particles (A) and a plurality of silicon-based particles (B) were mixed to obtain an anode mixture. The content (B/A) of the plurality of silicon-based particles (B) with respect to the plurality of carbon particles (A) was the ratio shown in Table 1.

### [2] Evaluation of Capacity Retention

### [2.1] Production of Lithium Secondary Battery

A lithium secondary battery was prepared as follows.

### [2.1.1] Positive Electrode

A LiNiCoMnO₂ was prepared as the positive electrode active material. As a conductive aid, acetylene black (AB) was prepared. Polyvinylidene fluoride (PVdF) was prepared as a binder.

A positive electrode mixture paste was prepared by mixing a positive electrode active material, a conductive auxiliary agent, a binder, and a solvent. The mass ratio of the positive electrode mixture paste (positive electrode active material:conductive auxiliary agent:binder) was 92:5:3. The positive electrode mixture paste was applied to an aluminum foil (thickness: 15 m), dried, and pressed. As a result, a positive electrode was obtained. The thickness of the positive electrode active material layer of the positive electrode was a predetermined thickness.

### [2.1.2] Negative Electrode

Carboxymethylcellulose (CMC) was prepared as binder A. As binder B, styrene-butadiene rubber (SBR) was prepared.

The obtained anode mixture, the conductive auxiliary agent, the binder A, the binder B, and the solvent were mixed to prepare an anode mixture paste. The mass ratio of the anode mixture paste (negative electrode active material:conductive auxiliary agent:binder A:binder B) was 97:1:1:1. Incidentally, the insoluble CMC was calculated as the active material weight. The anode mixture paste was applied to a copper foil (thickness: 10 m), dried, and pressed. As a result, a negative electrode was obtained. The thickness of the positive electrode active material layer of the negative electrode was a predetermined thickness.

### [2.1.3] Separator

As a separator, a porous sheet having a three-layer structure (thickness: 24 m) was prepared. The porous sheet is formed by laminating a polypropylene (PP) layer, a polyethylene (PE) layer, and a PP layer in this order. A layer (4 m) of ceramic (alumina, boehmite, etc.) was applied to one side of the separator.

### [2.1.4] Non-Aqueous Electrolyte

As a non-aqueous electrolyte, a mixture of a mixed solvent and LiPF₆ as a support salt was prepared. The mixed solvents consist of ethylene carbonate (EC), dimethyl carbonate (DMC) and ethyl methyl carbonate (EMC). The volume ratio (EC:DMC:EMC) of the mixed solvents was 3:3:4. The density of LiPF₆ was 1 mol/L.

### [2.1.5] Assembly

The positive electrode and the negative electrode were wound with a separator interposed therebetween to form an electrode group. The ceramic layer of the separator was opposite the positive electrode. A current collector plate with a lid was welded to both ends of the electrode group, the electrode group was inserted into the case, and the lid plate and the case were welded. A predetermined amount of non-aqueous electrolyte was injected from the injection hole of the case, and a sealing screw was tightened to the injection hole. After injection of the non-aqueous electrolyte solution, the electrode group was impregnated with the non-aqueous electrolyte solution at an appropriate time, the electrode group was charged, and aged at 60° C. As a result, a lithium secondary battery was obtained.

### [2.2] Evaluation of Life (Cycle) Characteristics

The lithium secondary batteries were charged and discharged so that the rate-loading became 2 C in a 60° C. atmosphere. SOC ranged from 0% to 100%, was performed for 300 cycles, and the battery capacity at the time of the first discharge (hereinafter, also referred to as “first capacity”) and the battery capacity after 300 cycles (hereinafter, also referred to as “300 cycle capacity”) were measured. The capacity retention ratio was calculated from the following formula (A). The results are shown in Table 1. The higher the capacity retention ratio, the better the battery characteristics can be evaluated. An acceptable range of capacity retention is 79% or more.

$$Capacity retention ratio ( \% ) = ( 300 cycles after cycle / initial capacity ) \times 100 \qquad Formula ( A )$$

### [3] Results

TABLE 1

| | Carbon particles (A) | | | | | | | | | |
|---|---|---|---|---|---|---|---|---|---|---|
| | Scaly graphite particles (A1) | | | | | Spherical | | | | |
| | | Scaly | | | | graphite | | Silicon- | | |
| | | graphite | Carbon | | | particles | | based | | |
| | | particles | film | | | (A2) | | particles (B) | | Evaluation |
| | | (a1) | (a2) | | Content | | Content | | Content | Capacity |
| | | Boron | Boron | Strength | (X/A) | | (A2/A) | | (B/A) | maintaining |
| | Particle | doping | doping | ratio | mass | Particle | mass | Particle | mass | rate |
| | type | atm % | atm % | (D/G) | % | type | % | type | % | % |
| Comparative | a1-1 | 0 | — | 0.1 | 30.0 | A2-1 | 70.0 | B-1 | 20 | 76 |
| Example 1 | | | | | | | | | | |
| Comparative | X-1 | 0 | 0 | 0.1 | 30.0 | A2-1 | 70.0 | B-1 | 20 | 78 |
| Example 2 | | | | | | | | | | |
| Example 1 | A1-1 | 0 | 0.2 | 0.3 | 30.0 | A2-1 | 70.0 | B-1 | 20 | 81 |
| Example 2 | A1-2 | 1.4 | 0.2 | 0.4 | 30.0 | A2-1 | 70.0 | B-1 | 20 | 86 |
| Example 3 | A1-3 | 0 | 1.4 | 0.3 | 30.0 | A2-1 | 70.0 | B-1 | 20 | 82 |
| Example 4 | A1-4 | 0 | 2.4 | 0.4 | 30.0 | A2-1 | 70.0 | B-1 | 20 | 83 |
| Example 5 | A1-5 | 1.4 | 1.3 | 0.3 | 30.0 | A2-1 | 70.0 | B-1 | 20 | 85 |
| Example 6 | A1-6 | 1.4 | 2.4 | 0.5 | 30.0 | A2-1 | 70.0 | B-1 | 20 | 86 |
| Example 7 | A1-7 | 1.4 | 0.2 | 0.3 | 30.0 | A2-1 | 70.0 | B-1 | 20 | 82 |
| Example 8 | A1-8 | 1.4 | 0.2 | 0.8 | 30.0 | A2-1 | 70.0 | B-1 | 20 | 81 |
| Comparative | X-2 | 1.4 | 0.2 | 0.9 | 0.5 | A2-1 | 99.5 | B-1 | 20 | 78 |
| Example 3 | | | | | | | | | | |
| Example 9 | A1-7 | 1.4 | 0.2 | 0.3 | 1.0 | A2-1 | 99.0 | B-1 | 20 | 80 |
| Example 10 | A1-7 | 1.4 | 0.2 | 0.3 | 10.0 | A2-1 | 90.0 | B-1 | 20 | 83 |
| Example 11 | A1-7 | 1.4 | 0.2 | 0.3 | 80.0 | A2-1 | 20.0 | B-1 | 20 | 82 |
| Comparative | A1-7 | 1.4 | 0.2 | 0.3 | 90.0 | A2-1 | 10.0 | B-1 | 20 | 78 |
| Example 4 | | | | | | | | | | |
| Comparative | A1-7 | 1.4 | 0.2 | 0.3 | 30.0 | A2-1 | 70.0 | B-1 | 1 | 78 |
| Example 5 | | | | | | | | | | |
| Example 12 | A1-7 | 1.4 | 0.2 | 0.3 | 30.0 | A2-1 | 70.0 | B-1 | 5 | 81 |
| Example 13 | A1-7 | 1.4 | 0.2 | 0.3 | 30.0 | A2-1 | 70.0 | B-1 | 10 | 82 |
| Example 14 | A1-7 | 1.4 | 0.2 | 0.3 | 30.0 | A2-1 | 70.0 | B-1 | 50 | 80 |
| Example 15 | A1-7 | 1.4 | 0.2 | 0.3 | 30.0 | A2-1 | 70.0 | B-1 | 60 | 79 |
| Comparative | A1-7 | 1.4 | 0.2 | 0.3 | 30.0 | A2-1 | 70.0 | B-1 | 70 | 74 |
| Example 6 | | | | | | | | | | |
| Example 16 | A1-9 | 0.2 | 0.2 | 0.4 | 30.0 | A2-1 | 70.0 | B-1 | 20 | 83 |
| Example 17 | A1-10 | 3.5 | 0.2 | 0.4 | 30.0 | A2-1 | 70.0 | B-1 | 20 | 84 |

In Table 1, “carbon film (a2)” represents a boron-doped low-crystallinity carbon film (a2). The “-” in the carbon film (a2) of Comparative Example 1 indicates that no boron-doped low-crystalline carbon film (a2) is formed.

The anode mixture of Comparative Example 1 to Comparative Example 3 did not contain coated graphite particles (A1). Therefore, the capacity retention ratio of Comparative Example 1 was not 79% or more.

In the anode mixture of Comparative Example 4, the content (A1/A) was not 0.8 mass % to 85.0 mass %. Therefore, the capacity retention ratio of Comparative Example 1 was not 79% or more.
From these results, it was found from Comparative Example 1 that the anode mixture of Comparative Example 4 was not an “anode mixture capable of improving the capacity retention ratio of the lithium secondary battery”.

The anode mixture of Examples 1 to 17 contained a plurality of carbon particles (A) and a plurality of silicon-based particles (B). The plurality of carbon particles (A) included coated graphite particles (A1). The coated graphite particles (A1) had scaly graphite particles (a1) and boron-doped low-crystallinity-carbon films (a2). The content (B/A) was from 5% to 60% by weight. The content (A1/A) was 0.8 mass % to 85.0 mass %. The intensity ratio (D/G) of the Raman spectrum of the coated graphite particles (A1) was from 0.3 to 0.8. Therefore, the capacity retention rates of Examples 1 to 17 were 79% or more.

From these results, it was found that the anode mixture of Examples 1 to 17 was an “anode mixture capable of improving the capacity retention ratio of the lithium secondary battery”.

What is claimed is:

1. An anode mixture comprising:
a plurality of carbon particles; and
a plurality of silicon-based particles, wherein:
the carbon particles include a coated graphite particle;
the coated graphite particle includes
a scaly graphite particle, and
a carbon film doped with boron and covering at least part of a surface of the scaly graphite particle;
an intensity ratio of a Raman spectrum of the coated graphite particle is 0.3 to 0.8;
a content of the silicon-based particles relative to the carbon particles is 5 mass % to 60 mass %; and
a content of the coated graphite particle relative to the carbon particles is 0.8 mass % to 85.0 mass %.

2. The anode mixture according to claim 1, wherein the scaly graphite particle is doped with boron.

3. The anode mixture according to claim 2, wherein a doping amount of the boron in the carbon film is 1.0 atm % or more.

4. The anode mixture according to claim 1, wherein:
the carbon particles further include a plurality of spherical graphite particles; and
a doping amount of the boron in the carbon film is 0.2 atm % to 2.4 atm %.

5. A lithium secondary battery comprising an anode including the anode mixture according to claim 1.
